(19) United States
(12) Patent Application Publication
(10) Pub. No.: US 2015/0201471 A1
(43) Pub. Date: Jul. 16, 2015

(54) LOW-FLICKER LIGHT-EMITTING DIODE LIGHTING DEVICE HAVING MULTIPLE DRIVING STAGES

(71) Applicant: IML International, Grand Cayman (KY)

(72) Inventors: Horng-Bin Hsu, Taipei City (TW); Yi-Mei Li, New Taipei City (TW); Yung-Hsin Chiang, New Taipei City (TW)

(21) Appl. No.: 14/555,703

(22) Filed: Nov. 28, 2014

Related U.S. Application Data
(60) Provisional application No. 61/927,993, filed on Jan. 16, 2014.

(51) Int. Cl. H05B 33/08

(52) U.S. Cl. CPC H05B 33/0812

(57) ABSTRACT

An LED lighting device includes multiple luminescent devices driven by a rectified AC voltage. The multiple luminescent devices are turned on flexibly in a multi-stage driving scheme using multiple current control units. At least one charge storage unit is coupled in parallel with at least one luminescent device. When the rectified AC voltage is still insufficient to turn on the at least one luminescent device, the at least charge storage unit is configured to discharge energy to the at least one luminescent device, thereby keeping the at least one luminescent device turned on.

### CROSS REFERENCE TO RELATED APPLICATIONS

This application claims the benefit of U.S. provisional application No. 61/927,993 filed on Jan. 16, 2014.

### BACKGROUND OF THE INVENTION

1. Field of the Invention

The present invention is related to an LED lighting device having multiple driving stages, and more particularly, to a low-flicker LED lighting device having multiple driving stages for providing wide operational voltage range, high reliability and low flicker.

2. Description of the Prior Art

An LED lighting device directly driven by a rectified alternative-current (AC) voltage usually adopts a plurality of LEDs coupled in series in order to provide required luminance. As the number of the LEDs increases, a higher forward-bias voltage is required for turning on the LED lighting device, thereby reducing the effective operational voltage range of the LED lighting device. As the number of the LEDs decreases, the large driving current when the rectified voltage is at its maximum level may impact the reliability of the LEDs.

An LED lighting device is configured to modulate luminous flux and intensity. This time variation is commonly referred to as flicker. LED flicker, whether perceptible or not, has been a concern of the lighting community because of its potential human impacts, which range from distraction, mild annoyance to neurological problems. Therefore, there is a need for an LED lighting device capable of improving the effective operational voltage range, the reliability and the flicker phenomenon.

### SUMMARY OF THE INVENTION

The present invention provides an LED lighting device having multiple driving stages. A first driving stage of the LED lighting device includes a first luminescent device driven by a rectified AC voltage for providing light according to a first current; and a first current controller configured to regulate the first current so that a current flowing through the first driving stage does not exceed a first value. A second driving stage of the LED lighting device includes a second luminescent device coupled in series to the first luminescent device and driven by the rectified AC voltage for providing light according to a second current; and a second current controller configured to regulate the second current so that a current flowing through the second driving stage does not exceed a second value. A charge storage unit of the LED lighting device is coupled in parallel with the first luminescent device and configured to discharge energy to the first luminescent device when the rectified AC voltage is insufficient to turn on the first luminescent device, thereby keeping the first luminescent device turned on.

The present invention provides an LED lighting device having multiple driving stages. A first driving stage of the LED lighting device includes a first luminescent device driven by a rectified AC voltage for providing light according to a first current; and a first current controller configured to regulate the first current so that a current flowing through the first driving stage does not exceed a first value. A second driving stage of the LED lighting device includes a second luminescent device coupled in series to the first luminescent device and driven by the rectified AC voltage for providing light according to a second current; and a second current controller configured to regulate the second current so that a current flowing through the second driving stage does not exceed a second value. A charge storage unit of the LED lighting device is coupled in parallel with the first luminescent device and the second luminescent device and configured to discharge energy to the first luminescent device and the second luminescent device when the rectified AC voltage is insufficient to turn on the first luminescent device and the second luminescent device, thereby keeping the first luminescent device and the second luminescent device turned on.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are diagrams of LED lighting devices according to embodiments of the present invention.

FIGS. 5-6 are diagrams illustrating the current-voltage characteristic of the luminescent devices in the LED lighting device of the present invention.

FIG. 7 is a diagram illustrating the current-time characteristic of the luminescent devices in the LED lighting device of the present invention.

FIG. 8 is a diagram illustrating the overall operation of an LED lighting device according to embodiments of the present invention.

FIG. 9 is a diagram illustrating the overall operation of an LED lighting device.

### DETAILED DESCRIPTION

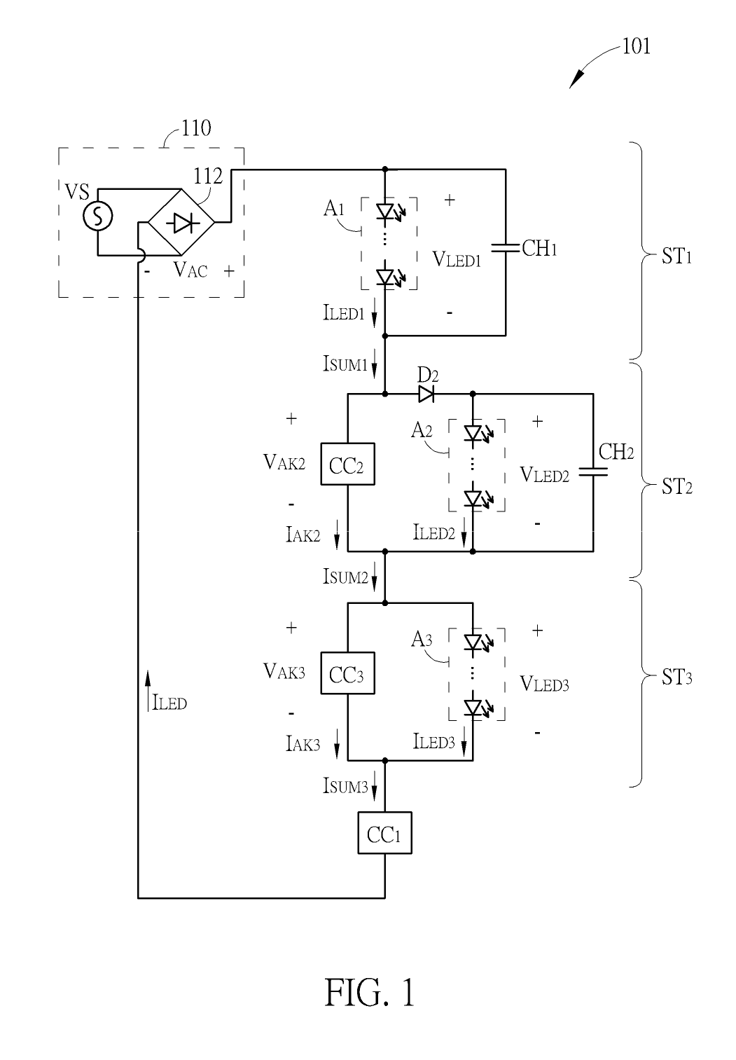

FIGS. 1-4 are diagrams of LED lighting devices 101-104 according to embodiments of the present invention. Each of the LED lighting devices 101-104 includes a power supply circuit 110, N luminescent devices A₁˜A_{N}, at least one of path controllers D₁˜D_{M}, N current control units CC₁˜CC_{N}, and M charge storage units CH₁˜CH_{M}, wherein N is a positive integer larger than 1, and M is a positive integer smaller or equal to N. The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the LED lighting devices 101-104. In another embodiment, the power supply circuit 110 may receive any AC voltage VS, perform voltage conversion using an AC-AC converter, and rectify the converted AC voltage VS using the bridge rectifier 112, thereby providing the rectified AC voltage V_{AC} whose value varies periodically with time. The configuration of the power supply circuit 110 does not limit the scope of the present invention.

In the LED lighting devices 101-104, the luminescent devices A₁˜A_{N} may be driven in N driving stages represented by ST₁˜ST_{N}. In the present invention, each of the luminescent devices A₁˜A_{N} may adopt a single LED or multiple LEDs coupled in series. FIGS. 1-4 depict the embodiment using multiple LEDs which may consist of single-junction LEDs, multi-junction high-voltage (HV) LEDs, or any combination of various types of LEDs. However, the types and configurations of the luminescent devices A₁˜A_{N} do not limit the scope of the present invention. In a specific driving stage, the dropout voltage V_{DROP} for turning on the corresponding current control unit is smaller than the cut-in voltage V_{CUT} for turning on the corresponding luminescent device. When the voltage established across a specific luminescent device exceeds its cut-in voltage V_{CUT}, the specific luminescent device may be placed in a conducting ON state; when the voltage established across the specific luminescent device does not exceed its cut-in voltage V_{CUT}, the specific luminescent device may be placed in a non-conducting OFF state. The value of the cut-in voltage V_{CUT} is related to the number or type of the LEDs in the corresponding luminescent device and may vary in different applications.

In the LED lighting devices 101-104, each of the M charge storage units CH₁˜CH_{M} may adopt a capacitor, or one or multiple devices which provides similar function. However, the types and configurations of the charge storage units CH₁˜CH_{M} do not limit the scope of the present invention.

In the LED lighting devices 101-104, each of the path controllers D₁˜D_{M} may adopt a diode, a diode-connected field effect transistor (FET), a diode-connected bipolar junction transistor (BJT) or other devices having similar function, or one or multiple devices which provides similar function. However, the types and configurations of the path controllers D₁˜D_{M} do not limit the scope of the present invention. When the voltage established across a specific path controller exceeds its turn-on voltage, the specific path controller is forward-biased and functions as a short-circuited device; when the voltage established across the specific path controller does not exceed its turn-on voltage, the specific path controller is reverse-biased and functions as an open-circuited device.

In FIGS. 1-4, V_{LED1}˜V_{LEDN} represent the voltages established across the luminescent devices A₁˜A_{N}, respectively. I_{LED1}˜I_{LEDN} represent the currents flowing through the luminescent devices A₁˜A_{N}, respectively. V_{AK2}˜V_{AKN} represent the voltages established across the current control units CC₂˜CC_{N}, respectively. I_{AK2}˜I_{AKN} represent the currents flowing through the current control units CC₂˜CC_{N}, respectively. I_{SUM1}˜I_{SUMN} represent the current flowing through the corresponding driving stages ST₁˜ST_{N}, respectively. I_{LED} represents the overall current flowing through the LED lighting devices 101-104.

In the LED lighting device 101 depicted in FIG. 1, the current control unit CC₁ is coupled in series to the luminescent device A₁, and the current control units CC₂˜CC_{N} are coupled in parallel with the luminescent devices A₂˜A_{N}, respectively. The charge storage units CH₁˜CH_{M} are coupled in parallel with any M luminescent devices among the luminescent devices A₁˜A_{N}, respectively. The path controller D₂˜D_{M} are coupled between corresponding current control units CC₂˜CC_{M} and the corresponding charge storage units CH₂˜CH_{M}. The current control units CC₁˜CC_{N} are configured to regulate the current I_{LED1}˜I_{LEDN} so that the current I_{SUM1}˜I_{SUMN} does not exceed the maximum current settings I_{SET1}=I_{SETN} of the 1^{st} to N^{th} driving stages ST₁˜ST_{N}, respectively.

The current control units CC₁˜CC_{N} can improve the effective operational voltage range and the reliability of the LED lighting device 101, while the charge storage units CH₁˜CH_{M} can reduce the flicker of the LED lighting device 101, wherein M may be smaller than or equal to N. In an embodiment when M=N, each driving stage includes a charge storage unit coupled in parallel with a corresponding luminescent device. In an embodiment when M<N, the M charge storage units CH₁˜CH_{M} may be coupled in parallel with the luminescent devices which have the longest turn-on time among the luminescent devices A₁˜A_{N}, such as coupled to the luminescent devices A₁˜A_{M} in the first M driving stages A₁˜A_{M}. For illustration purpose, FIG. 1 depicts the embodiment of N=3 and M=2 in which the LED lighting device 101 includes 3 luminescent devices A₁˜A₃ and the charge storage units CH₁˜CH₂ are coupled in parallel with the luminescent devices A₁˜A₂, respectively. However, the number and configuration of the charge storage units do not limit the scope of the present invention.

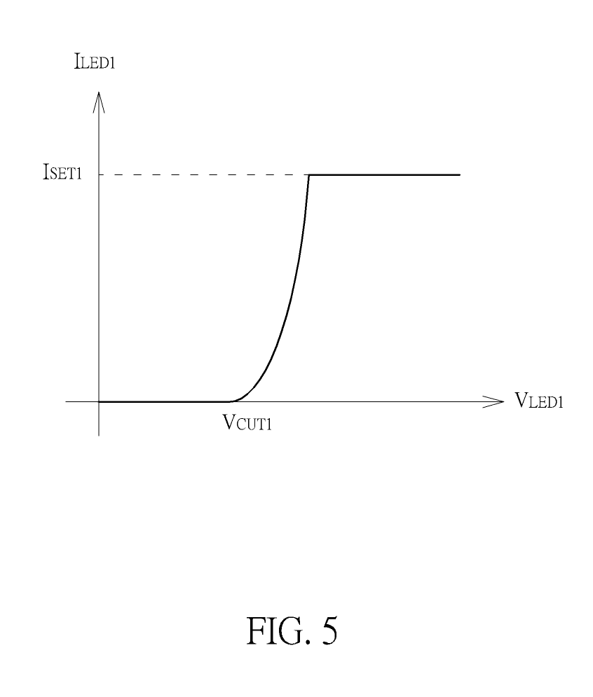

FIG. 5 is a diagram illustrating the current-voltage (I-V) characteristic of the luminescent device A₁ in the driving stage ST₁ of the LED lighting device 101. The voltage V_{LED1} established across the luminescent devices A₁ is associated with the rectified AC voltage V_{AC} whose value varies periodically with time. During the rising period or the falling period of the rectified AC voltage V_{AC} when the voltage V_{LED1} is smaller than a cut-in voltage V_{CUT1} of the luminescent device A₁, the luminescent device A₁ remains in OFF state. During the rising period or the falling period of the rectified AC voltage V_{AC} when the voltage V_{LED1} becomes sufficiently large to turn on the luminescent device A₁ (V_{LED1}>V_{CUT1}), the luminescent device A₁ is maintained in ON state by the rectified AC voltage V_{AC}. With the current I_{LED1} now increasing with the voltage V_{LED1}, the current control unit CC₂ is configured to regulate the current I_{LED1} so that the total current I_{SUM1} flowing through the 1^{st} driving stage ST₁ does not exceed the maximum current setting I_{SET2} of the 2^{nd} driving stage ST₂.

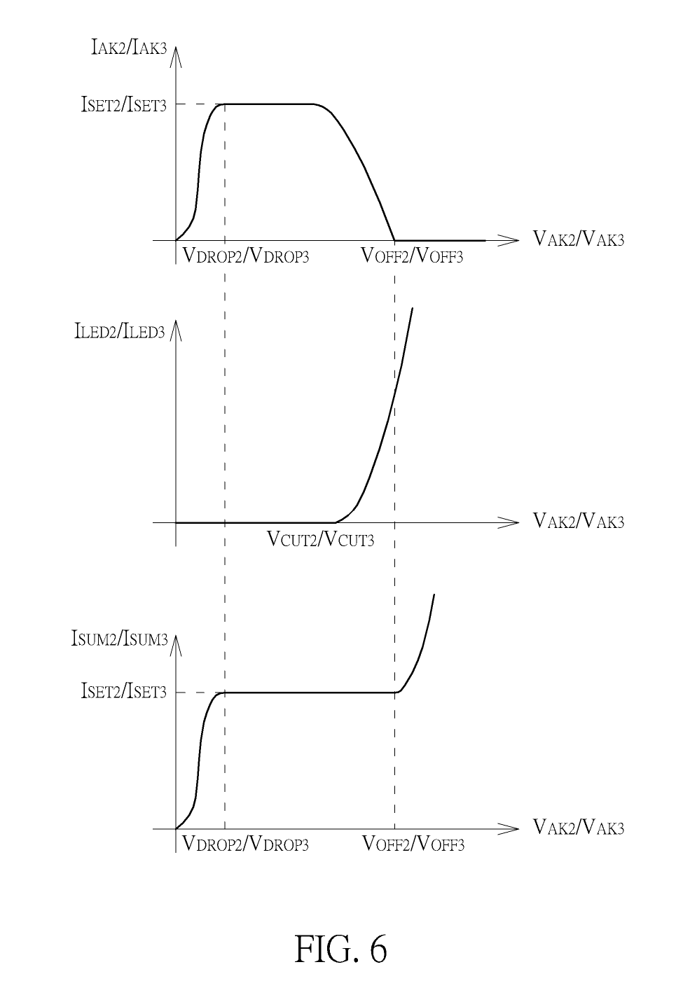

FIG. 6 is a diagram illustrating the I-V characteristic of the driving stages ST₂˜ST₃ in the LED lighting device 101. During the rising period or the falling period of the rectified AC voltage V_{AC} when the voltage V_{AK2} does not exceed a drop-out voltage V_{DROP2} of the current control unit CC₂ or the voltage V_{AK3} does not exceed a drop-out voltage V_{DROP3} of the current control unit CC₃, the current control unit CC₂/CC₃ is not completely turned on and operates as a voltage-controlled device in a linear mode in which the current I_{AK2} changes with the voltage V_{AK2} and the current I_{AK3} changes with the voltage V_{AK3} in a specific manner. For example, if the current control unit CC₂/CC₃ adopts an N-type metal-oxide-semiconductor (NMOS) transistor, the relationship between the current I_{AK2} and the voltage V_{AK2} or the relationship between the current I_{AK3} and the voltage V_{AK3} may be determined by the relationship between the drain current and the drain-to-source voltage of the NMOS transistor.

During the rising period or the falling period of the rectified AC voltage V_{AC} when V_{AK2}>V_{DROP2} or V_{AK3}>V_{DROP3}, the current I_{SUM2} reaches the maximum current setting I_{SET2} of the 2^{nd} driving stage ST₂ or the current I_{SUM3} reaches the maximum current setting I_{SET3} of the 3^{rd} driving stage ST₃. In response, the current control unit CC₂/CC₃ switches to a constant-current mode and functions as a current limiter so that the total current I_{SUM2} flowing through the 2^{nd} driving stage ST₂ may be maintained at the constant value I_{SET2} instead of changing with the voltage V_{AK2} or the total current I_{SUM3} flowing through the 3^{rd} driving stage ST₃ may be maintained at the constant value I_{SET3} instead of changing with the voltage V_{AK3}.

When the voltage V_{AK2} reaches a turn-off voltage V_{OFF2} or the voltage V_{AK3} reaches a turn-off voltage V_{OFF3}, the current I_{AK2}/I_{AK3} drops to zero and the current control unit CC₂/CC₃ switches to a cut-off mode. In other words, the current control unit CC₂/CC₃ functions as an open-circuited device, thereby allowing the current I_{LED2} and the current I_{SUM2} to increase with the voltage V_{AK2} or allowing the current I_{LED3} and the current I_{SUM3} to increase with the voltage V_{AK3}.

In the embodiment depicted in FIG. 6, the current settings I_{SET2} and I_{SET3}, the drop-out voltages V_{DROP2} and V_{DROP3}, and the turn-off voltages V_{OFF2} and V_{OFF3} have the same scale. However, the current Settings I_{SET2} and I_{SET3}, the drop-out voltages V_{DROP2} and V_{DROP3}, and the turn-off voltages V_{OFF2} and V_{OFF3} may also have different values.

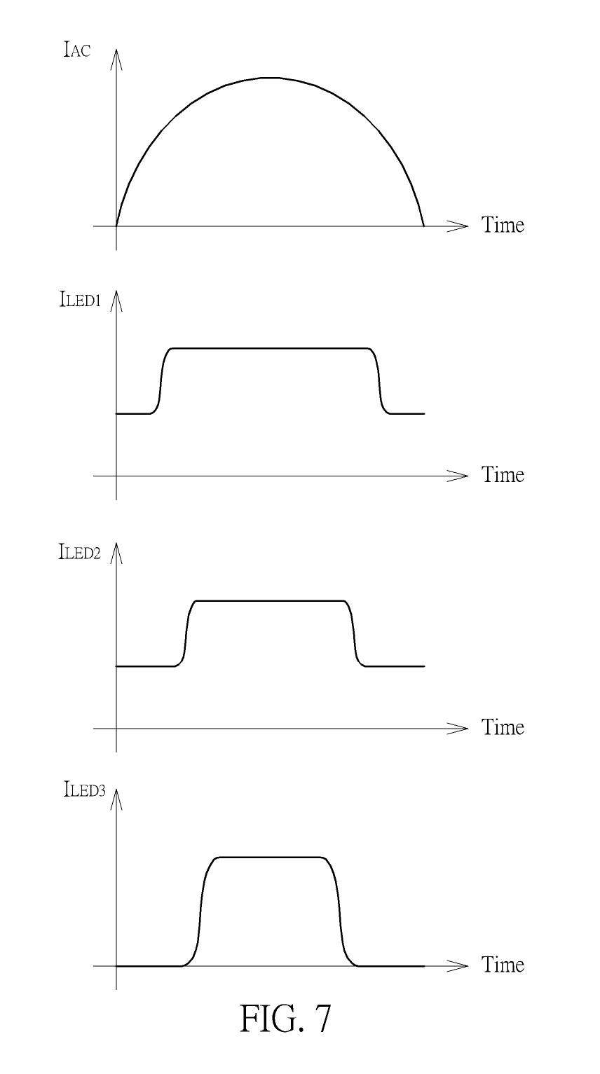

FIG. 7 is a diagram illustrating the current-time characteristic of the luminescent devices A₁˜A₃ in the LED lighting device 101. During the rising period before the rectified AC voltage V_{AC} becomes sufficiently large to turn on the luminescent devices A₁˜A₃, the luminescent device A₃ remains in OFF state, while the luminescent devices A₁˜A₂ may be maintained in ON state by the energy discharged from the charge storage units CH₁ and CH₂, respectively. The path controller D₂ is arranged to prevent the energy stored in the charge storage unit CH₂ from being discharged through the current control unit CC₂.

During the rising period or the falling period when the rectified AC voltage V_{AC} becomes sufficiently large, the luminescent devices A₁˜A₃ may be maintained in ON state by the rectified AC voltage V_{AC}, which is now charging the charge storage units CH₁ and CH₂.

During the falling period after the rectified AC voltage V_{AC} is no longer sufficiently large to turn on the luminescent devices A₁˜A₃, the luminescent device A₃ remains in OFF state, while the luminescent devices A₁˜A₂ may still be maintained in ON state by the energy discharged from the charge storage units CH₁ and CH₂, respectively. The path controller D₂ is arranged to prevent the energy stored in the charge storage unit CH₂ from being discharged through the current control unit CC₂.

As depicted in FIG. 7, the introduction of the charge storage units CH₁ and CH₂ allow the luminescent devices A₁ and A₂ to have longer turn-on time than the luminescent device A₃.

In the LED lighting device 102, the current control units CC₁˜CC_{N} are coupled in series to the luminescent devices A₁˜A_{N}, respectively. The charge storage units CH₁˜CH_{M} are coupled in parallel with any M luminescent devices among the luminescent devices A₁˜A_{N}, respectively. The path controller D₂˜D_{M} are coupled between corresponding current control units CC₂˜CC_{M} and the corresponding charge storage units CH₂˜CH_{M}. The current control units CC₁˜CC_{N} are configured to regulate the current I_{SUM1}˜I_{SUMN} so that the current I_{SUM1}˜I_{SUMN} does not exceed the maximum current settings I_{SET1}˜I_{SETN} of the 1^{st} to N^{th} driving stages ST₁˜ST_{N}, respectively.

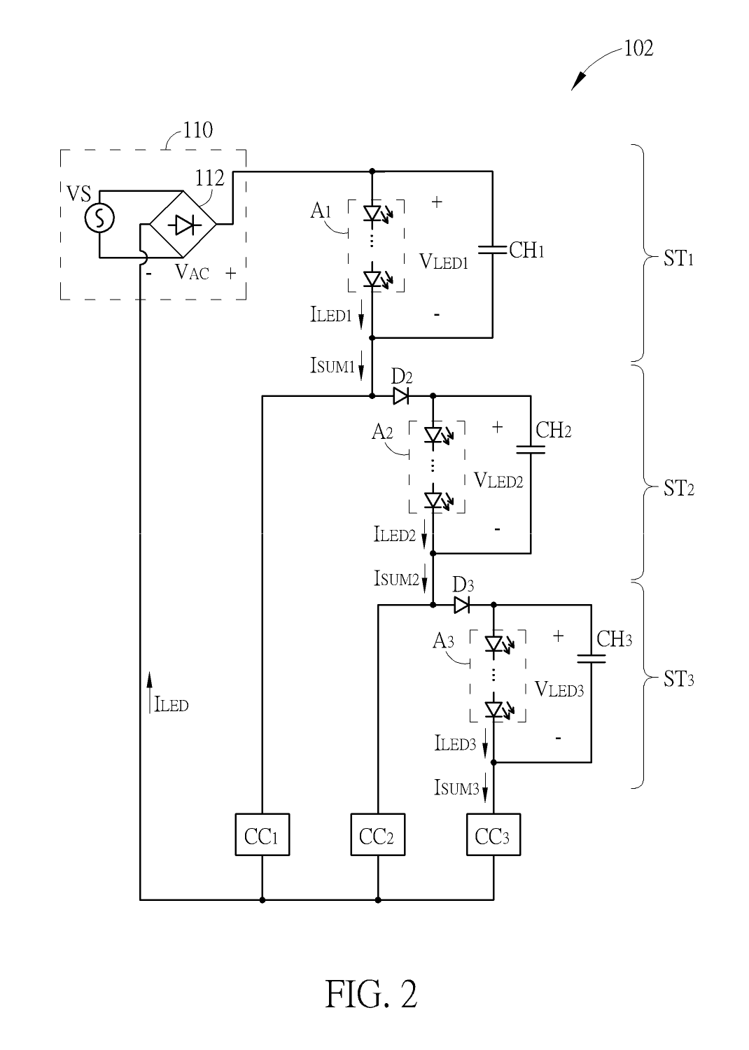

The current control units CC₁˜CC_{N} can improve the effective operational voltage range and the reliability of the LED lighting device 102, while the charge storage units CH₁˜CH_{M} can reduce the flicker of the LED lighting device 102, wherein M may be smaller than or equal to N. In an embodiment when M=N, each driving stage includes a charge storage unit coupled in parallel with a corresponding luminescent device. In an embodiment when M<N, the M charge storage units CH₁˜CH_{M} may be coupled in parallel with the luminescent devices which have the longest turn-on time among the luminescent devices A₁˜A_{N}, such as coupled to the luminescent devices A₁˜A_{M} in the first M driving stages A₁˜A_{M}. For illustration purpose, FIG. 2 depicts the embodiment of N=M=3 in which the LED lighting device 102 includes 3 luminescent devices A₁˜A₃ respectively coupled in parallel with the charge storage units CH₁˜CH₃. However, the number and configuration of the charge storage units do not limit the scope of the present invention.

The operation of each driving stage of the LED lighting device 102 may also be illustrated in accordance with FIGS. 5˜7. During the rising period or the falling period when the rectified AC voltage V_{AC} is small, the luminescent devices A₁˜A₃ may still be maintained in the ON state by the energy discharged from the charge storage units CH₁˜CH₃, respectively.

In the LED lighting devices 103 and 104, at least one charge storage unit CH₁ is coupled in parallel with M consecutive luminescent devices among the luminescent devices A₁˜A_{N}. At least one path controller D₁ is coupled between a corresponding current control unit and the charge storage unit CH₁.

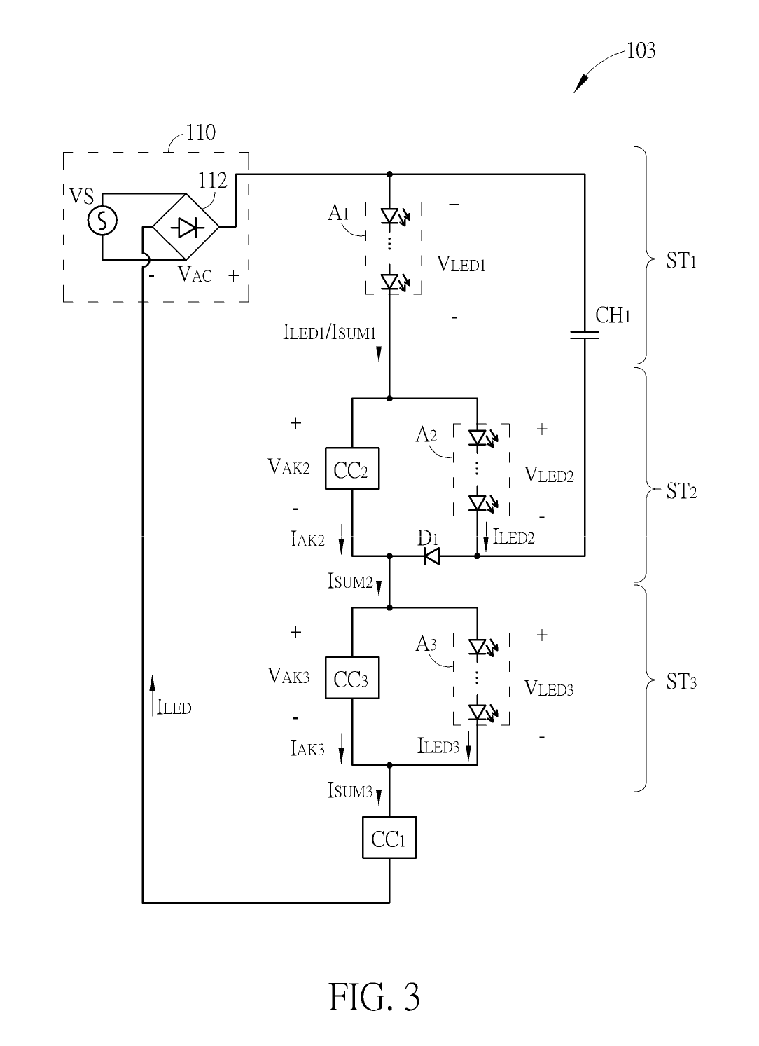

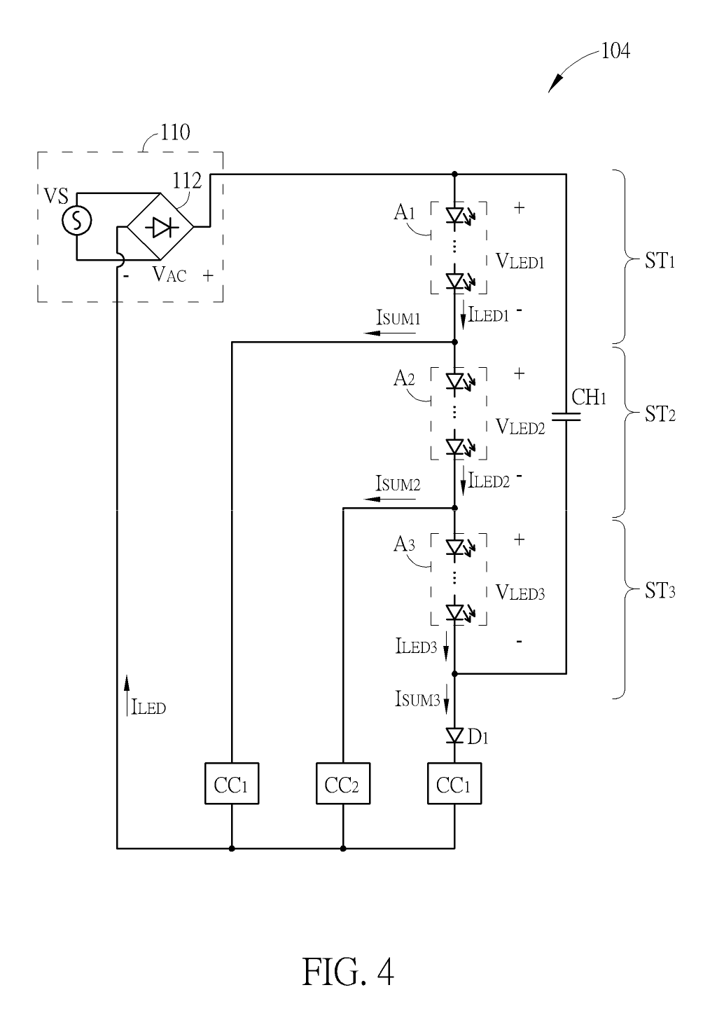

The current control units CC₁˜CC_{N} can improve the effective operational voltage range and the reliability of the LED lighting devices 103 and 104, while the charge storage unit CH₁ can reduce the flicker of the LED lighting devices 103 and 104, wherein M may be any number between 2 and N. In an embodiment when M=N, the charge storage unit CH₁ is coupled in parallel with the luminescent devices A₁˜A_{N} in all driving stages. In an embodiment when M<N, the charge storage unit CH₁ may be coupled in parallel with the M luminescent devices which have the longest turn-on time among the luminescent devices A₁˜A_{N}, such as coupled to the luminescent devices A₁˜A_{P} in the first P driving stages A₁˜A_{P}. For illustration purpose, FIG. 3 depicts the embodiment of N=3 and M=2 in which the LED lighting device 103 includes 3 luminescent devices A₁˜A₃ and the charge storage unit CH₁ is coupled in parallel with the luminescent devices A₁˜A₂. FIG. 4 depicts the embodiment of N=M=3 in which the LED lighting device 102 includes 3 luminescent devices A₁˜A₃ and the charge storage unit CH₁ is coupled in parallel with the luminescent devices A₁˜A₃. However, the number and configuration of the charge storage units do not limit the scope of the present invention.

The operation of each driving stage of the LED lighting device 103 or 104 may also be illustrated in accordance with FIGS. 5-7. During the rising period or the falling period when the rectified AC voltage V_{AC} is small, the luminescent devices A₁˜A₃ may still be maintained in the ON state by the energy discharged from the charge storage unit CH₁.

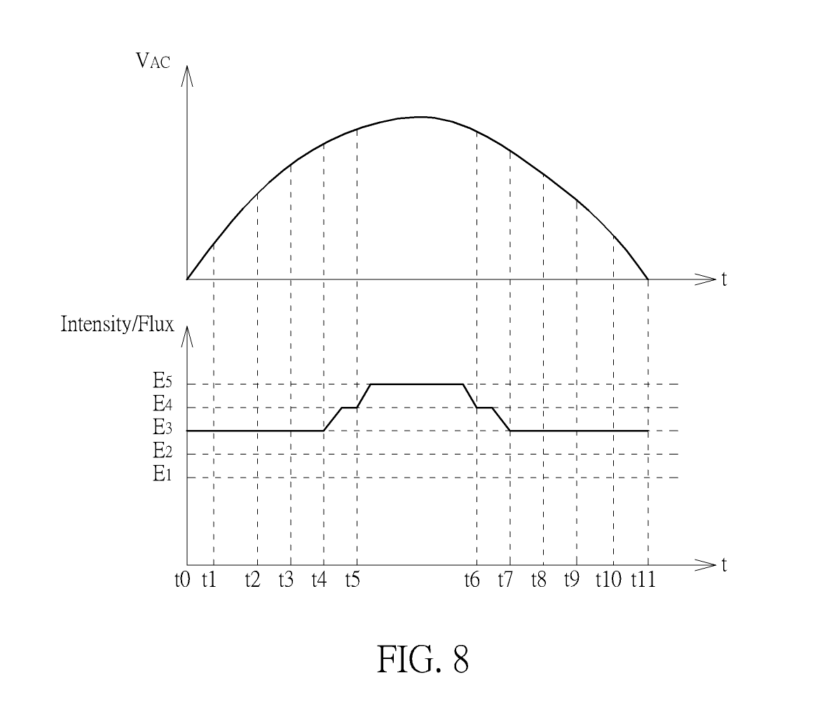

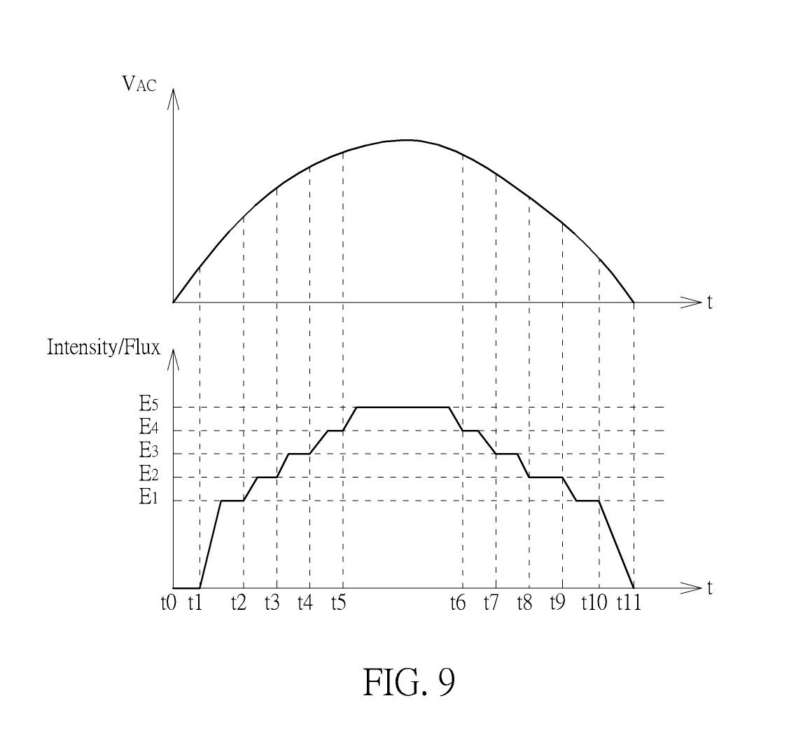

FIG. 8 is a diagram illustrating the overall operation of the LED lighting devices 101-104 when 3 luminescent devices A₁˜A₃ (M=3) among the luminescent devices A₁˜A₅ (N=5) are coupled in parallel to respective charge storage units CH₁˜CH₃ (as shown in FIG. 1 or FIG. 2) or coupled in parallel to one charge storage unit CH₁ (as shown in FIG. 3 or FIG. 4). FIG. 9 is a diagram illustrating the overall operation of the LED lighting devices 101-104 when no charge storage unit is adopted. E₁˜E₅ represent the overall intensity/flux of the present LED lighting devices 101˜104. It is to be noted that FIG. 9 is used to illustrate how flicker can be improved using the present charge storage units, but is by no means an intended configuration of present invention.

Since the voltages V_{AK1}˜V_{AK5} are associated with the rectified AC voltage V_{AC} whose value varies periodically with time, a driving cycle of t₀-t₁₁ is used for illustration, wherein the period between t₀-t₅ belongs to the rising period of the rectified AC voltage V_{AC} and the period between t₆-t₁₁ belongs to the falling period of the rectified AC voltage V_{AC}. The following Table 1 lists the operational modes of the luminescent devices A₁˜A₅ in accordance with the configuration depicted in FIG. 8. The following Table 2 lists the operational modes of the luminescent devices A₁˜A₅ in accordance with the configuration depicted in FIG. 9.

TABLE 1

| luminescent | t0~t1 | t1~t2 | t2~t3 | t3~t4 | t4~t5 | |
|---|---|---|---|---|---|---|
| device | t10~t11 | t9~t10 | t8~t9 | t7~t8 | t6~t7 | t5~t6 |
| A₁ | ON | ON | ON | ON | ON | ON |
| A₂ | ON | ON | ON | ON | ON | ON |
| A₃ | ON | ON | ON | ON | ON | ON |
| A₄ | OFF | OFF | OFF | OFF | ON | ON |
| A₅ | OFF | OFF | OFF | OFF | OFF | ON |

TABLE 2

| luminescent | t0~t1 | t1~t2 | t2~t3 | t3~t4 | t4~t5 | |
|---|---|---|---|---|---|---|
| device | t10~t11 | t9~t10 | t8~t9 | t7~t8 | t6~t7 | t5~t6 |
| A₁ | OFF | ON | ON | ON | ON | ON |
| A₂ | OFF | OFF | ON | ON | ON | ON |
| A₃ | OFF | OFF | OFF | ON | ON | ON |
| A₄ | OFF | OFF | OFF | OFF | ON | ON |
| A₅ | OFF | OFF | OFF | OFF | OFF | ON |

In FIG. 9 and Table 2, at the beginning of the rising cycle, the rectified AC voltage VAC is insufficient to turn on the luminescent devices A1˜A3. Without the present charge storage units, the luminescent devices A1˜A3 remain in the OFF state between t0˜t1 and are sequentially turned on as the rectified AC voltage VAC increases. More specifically, the overall intensity/flux of the present LED lighting devices 101˜104 increases stepwise and reaches E3 between t3˜t4 when all the luminescent devices A1˜A3 operate in the ON state.

In FIG. 8 and Table 1, at the beginning of the rising cycle, the rectified AC voltage VAC is insufficient to turn on the luminescent devices A1˜A3. With the present charge storage units, the luminescent devices A1˜A3 may be kept in the ON state during the entire driving period between t0˜t11 regardless of the rectified AC voltage VAC. More specifically, the overall intensity/flux of the present LED lighting devices 101˜104 is maintained at E3 between t0˜t4 when all the luminescent devices A1˜A3 operate in the ON state.

As well-known to those skilled in the art, LED flicker is periodic, with its waveforms characterized by variations in amplitude, average level, periodic frequency, shape, and/or duty cycle. Percent Flicker and Flicker Index are metrics historically used to quantify flicker, as represented by the following formula:

$$\begin{matrix}Percent Flicker = 100 \% \times \frac{MAX - MIN}{MAX + MIN} & ( 1 ) \\ Flicker Index = \frac{AREA 1}{AREA 1 + AREA 2} & ( 2 )\end{matrix}$$

In formula (1), MAX represents the maximum intensity/flux of the LED lighting devices 101˜104, while MIN represents the minimum intensity/flux of the LED lighting devices 101˜104. In formula (2), AREA1 represents the summation of intensity/flux within a duration of a driving cycle when the intensity/flux of the LED lighting devices 101˜104 is above its average, while AREA2 represents the summation of intensity/flux within a duration of the driving cycle when the intensity/flux of the LED lighting devices 101˜104 is below its average.

As can be seen in FIG. 8, the introduction of the charge storage units can increase MAX in formula (1) and AREA2 in formula (2), thereby lowering the Percent Flicker and Flicker Index of the LED lighting devices 101˜104.

With the above-mentioned multi-stage driving scheme, the present invention may turn on multiple luminescent devices flexibly using multiple current control units. With the above-mentioned charge storage units, the present invention may reduce luminous variation of the LED lighting device. Therefore, the present invention can provide an LED lighting device capable of improving the effective operational voltage range, the reliability and the flicker phenomenon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting diode (LED) lighting device having multiple driving stages, comprising:
a first driving stage including:
a first luminescent device driven by a rectified alternative-current (AC) voltage for providing light according to first current; and
a first current controller configured to regulate the first current so that current flowing through the first driving stage does not exceed a first value;
a second driving stage including:
a second luminescent device coupled in series to the first luminescent device and driven by the rectified AC voltage for providing light according to second current; and
a second current controller configured to regulate the second current so that current flowing through the second driving stage does not exceed a second value; and
a first charge storage unit coupled in parallel with the first luminescent device and configured to discharge energy to the first luminescent device when the rectified AC voltage is insufficient to turn on the first luminescent device, thereby keeping the first luminescent device turned on.

2. The LED lighting device of claim 1, wherein the first charge storage unit is further configured to stop discharging the energy to the first luminescent device and start to be charged by the rectified AC voltage when the rectified AC voltage become sufficient to turn on the first luminescent device.

3. The LED lighting device of claim 1, further comprising:
a second charge storage unit coupled in parallel with the second luminescent device and configured to discharge energy to the second luminescent device when the rectified AC voltage is insufficient to turn on the second luminescent device, thereby keeping the second luminescent device turned on.

4. The LED lighting device of claim 3, wherein:
the first current controller is coupled in series to the first luminescent device; and
the second current controller is coupled in parallel with the second luminescent device.

5. The LED lighting device of claim 4, further comprising:
a path controller coupled between the second current controller and the second charge storage unit and configured to isolate the energy discharged by the second charge storage unit from the second current controller.

6. The LED lighting device of claim 3, wherein:
the first current controller is coupled in series to the first luminescent device; and
the second current controller is coupled in series to the second luminescent device.

7. The LED lighting device of claim 6, further comprising:
a path controller coupled between the first current controller and the second charge storage unit and configured to isolate the energy discharged by the second charge storage unit from the first current controller.

8. The LED lighting device of claim 3, wherein the second charge storage unit is further configured to stop discharging the energy to the second luminescent device and start to be charged by the rectified AC voltage when the rectified AC voltage become sufficient to turn on the second luminescent device.

9. A light-emitting diode (LED) lighting device having multiple driving stages, comprising:
a first driving stage including:
a first luminescent device driven by a rectified alternative-current (AC) voltage for providing light according to first current; and
a first current controller configured to regulate the first current so that current flowing through the first driving stage does not exceed a first value;
a second driving stage including:
a second luminescent device coupled in series to the first luminescent device and driven by the rectified AC voltage for providing light according to second current; and
a second current controller configured to regulate the second current so that current flowing through the second driving stage does not exceed a second value; and
a charge storage unit coupled in parallel with the first luminescent device and the second luminescent device and configured to discharge energy to the first luminescent device and the second luminescent device when the rectified AC voltage is insufficient to turn on the first luminescent device and the second luminescent device, thereby keeping the first luminescent device and the second luminescent device turned on.

10. The LED lighting device of claim 9, wherein the charge storage unit is further configured to stop discharging the energy to the first luminescent device and the second luminescent device and start to be charged by the rectified AC voltage when the rectified AC voltage become sufficient to turn on the first luminescent device and the second luminescent device.

11. The LED lighting device of claim 9, wherein:
the first current controller is coupled in series to the first luminescent device; and
the second current controller is coupled in parallel with the second luminescent device.

12. The LED lighting device of claim 11, further comprising:
a path controller coupled between the second current controller and the charge storage unit and configured to isolate the energy discharged by the charge storage unit from the second current controller.

13. The LED lighting device of claim 9, wherein:
the first current controller is coupled in series to the first luminescent device; and
the second current controller is coupled in series to the second luminescent device.

14. The LED lighting device of claim 13, further comprising:
a path controller coupled between the first current controller and the charge storage unit and configured to isolate the energy discharged by the charge storage unit from the first current controller.
